(19) United States
(12) Patent Application Publication
(10) Pub. No.: US 2002/0155876 A1
(43) Pub. Date: Oct. 24, 2002

(54) Online lottery game of chance and method of and system for playing the game

(76) Inventors: Alan Taylor, Lancashire (GB); Andrew P. Gray, Halifax, West Yorkshire (GB)

Correspondence Address: Dike, Bronstein, Roberts & Cushman, Intellectual Property Practice Group, EDWARDS & ANGELL, LLP, 130 Water Street, Boston, MA, 02109, US

(21) Appl. No.: 09/794,266

(22) Filed: Feb. 27, 2001

(51) Int. Cl. G06F 17/00

(52) U.S. Cl. 463/17; 463/42

(57) ABSTRACT

A game of chance and a method and system for playing the game for a plurality of game participants that is based on “tic-tac-toe”. Game participants self-select or have selected automatically for them a plurality of playing game pieces from a population of game pieces. Game participants assign the plurality of playing game pieces into one of a plurality of discrete cells of at least one matrix that appears on each game ticket. A selection device randomly selects a plurality of winning game pieces from the same population of game pieces with or without replacement. Game participants can win a prize if a plurality of their playing game pieces match a plurality of winning game pieces to form one of more winning lines. A winning line comprises a plurality of matched playing game pieces, which are located in adjoining cells of the at least one matrix, forming one or more horizontal, vertical or diagonal “rows”. Thus, game participants can win some prize for matching fewer than all of the winning game pieces selected. Moreover, one or more winning lines are possible on each game ticket, producing a plurality of ways to win on a single ticket. The game is played online to facilitate determining the number of winning game tickets and the number of wining lines per winning game ticket; determining the prize payout amount; and authenticating at least one winning game ticket.

### FIELD OF THE INVENTION

The present invention relates to an online game of chance and a method of and system for playing the game. More precisely, the invention relates to an online lottery-type game of chance comprising a plurality of game participants any number of which can win at least one prize on the basis of a random drawing of game pieces selected from a population of game pieces.

### DESCRIPTION OF THE RELATED ART

A majority of the states in the United States have legalized public and private lottery-type games. The most common format in state and multi-state lotteries is a game, e.g., LOTTO, THE BIG GAME, POWERBALL, etc., in which game participants select, or have automatically selected for them, a plurality of playing game pieces, e.g., typically between about three and eight numbers, from a population of game pieces, e.g., integers from 1 to 49. Game participants purchase lottery tickets for a few dollars at a point of sale terminal, which are frequently located in grocery stores, convenience stores, smoke shops, and elsewhere, with the expectation of winning a jackpot prize whose value often exceeds one million and sometimes tens of millions of dollars. Game participants either personally select their own combination of “lucky numbers” or, in the alternative, an electronic, random number generator, which is connected to a central server through a network, produces a combination of playing game pieces for them, e.g., by “quick pick”.

The object of a lottery-type game is to match a game participant's playing game pieces with all or, in some instances, slightly less than all of a combination of winning game pieces, which are selected randomly in a lottery-type drawing. The odds of winning the game decrease significantly as the number of game pieces comprising the combination of winning game pieces increases. Lottery-type games are “linear”, however, in that with each successive drawing of winning game pieces, more and more game participants are excluded from winning the top prize. As a result, typically, only a relatively small number of total game participants win any prize. As a result, prizes, e.g., cash jackpots, are usually large.

Lottery-type drawings typically comprise a manual or electronic random drawing device, which select a combination of winning game pieces from the game piece population. Manual lottery drawings comprise the step of randomly selecting winning game pieces, e.g., numbered ping pong balls, from a drawing machine or drum. Electronic random drawing devices generally comprise the steps of randomly generating a combination of winning game pieces from the game piece population using a server having a database and software therefor.

In many instances, the lottery-type drawing is televised live on commercial television, e.g., after the evening news. In addition, results are typically published in local newspapers and posted at each point of sale. Game participants win the top, i.e., jackpot, prize if the combination of their playing game pieces exactly matches the combination of winning game piece drawn manually or generated electronically. Many lottery-type games, further, provide lesser prizes for matching most of the winning games pieces in the combination of winning game pieces. The dollar amount of the cash prize in these instances, however, is substantially smaller than the jackpot prize. When no one wins a particular drawing, the jackpot amount is carried over to the next drawing.

A shortcoming associated with a lottery-type game includes its linearity, which rapidly excludes most game participants from winning anything. Indeed, with a lottery-type game there is virtually only one way to win the jackpot prize and/or lesser prizes and very few game participants can win.

A variation of the lottery-type game is a keno-type game, which also uses a population of game pieces, e.g., numbers 1 to 80, from which a combination of winning game pieces is selected at random, e.g., by an electronic, random number generator. Keno-type games typically appear on a video display or closed circuit television, which shows each winning game piece as it is generated and which authenticates every game after each drawing event. Keno-type games differ from lottery-type games in a number of ways. First, the total population of game pieces for keno-type games typically is larger than lottery-type game populations. Moreover, more winning game pieces are selected in each keno-type drawing event than game participants need to win the top prize. As a result, game participants can lack some of the winning game pieces and still win the top prize. Indeed, more game participants can win some prize if not the top prize. Prizes, e.g., cash payoffs, however, typically are substantially smaller than lottery-type payoffs.

Furthermore, game participant can choose the number of winning game pieces that he or she will try to match, e.g., two, five, ten, etc. For example, if the total population of game pieces comprises 80 game pieces and 20 game pieces are selected per drawing event, a game participant who chooses to match ten game pieces can lack ten of the 20 winning game pieces and still win the top prize. However, the odds and, consequently, the dollar amount of cash prizes are greater when a game participant selects more playing game pieces to match the combination of winning game pieces. Shortcomings of keno-type game, though, include their inaccessibility to the general public and the game is not universally understood and play confuses some would-be participants.

Numerous U.S. and foreign patents have been issued to inventors for a variety of games and games of chance based on tic-tac-toe. Indeed, Patent Cooperation Treaty patent number WO 97/2791 to Marks et al. discloses an interactive tic-tac-toe game that is played between a pair of participants. The method of the game basically follows the conventional, simple tic-tac-toe format, which children throughout the world play. Indeed, the game of tic-tac-toe is simple and well understood: a plurality of X's and O's (or surrogate symbols therefor) are placed alternately in one of nine cells, or boxes, of a game board, or matrix, by one and then by the other participant. The object of the game, of course, remains getting three-in-a-row vertically, horizontally or diagonally before one's opponent. As a whole, however, the prior art has not advanced the simple child's game much beyond, e.g., a pencil and paper embodiment.

Interest and participation in current lottery-type games is often flat unless extraordinarily large cash jackpots accumulate following a series of weeks in which no one claims the cash jackpot. Furthermore, participants prefer simple games and simple formats. Moreover, new games of chance that are easily understood and provide for multiple winners are always in demand in the gambling and gaming industries.

### SUMMARY OF THE INVENTION

Accordingly, it would be desirable to produce a novel game of chance and a method of and system for playing the game that are based on a simple, well-known child's game to foster greater participation. Furthermore, it would be desirable to produce a game of chance and a method of and system for playing the game in which there are more than one possible combinations of winning game pieces on a single playing ticket, which allows more participants to win and, moreover, more winning combinations on a single ticket. Indeed, it would be desirable to produce a new game of chance and method of and system for playing the game that differs from typical lottery- or keno-type games.

Therefore, it is an object of this invention to produce a novel game of chance and a method of and system for playing the game that produce multiple possible winning combinations on a single playing ticket.

It is a further object of this invention to produce a novel game of chance and a method of and system for playing the game that allow more game participants to win.

It is another object of this invention to produce a novel game of chance and a method of and system for playing the game the rules of which are easily understood to encourage more people to participate.

It is yet another object of the present invention to produce a novel game of chance and method of and system for playing the game whose format differs from typical lottery- or keno-type games.

These and further objects are obtained by a novel game of chance and method of and system for playing the game in which game participants can select a plurality of playing game pieces from a population of game pieces. Furthermore, game participants can place their playing game pieces into a plurality of cells, or boxes, of a matrix, or grid, located on a game ticket. In an embodiment of the present invention, game participants selectively populate each matrix cell with a discrete playing game piece.

The game is played by randomly selecting or electronically generating a number of winning game pieces from the population of game pieces. Game participants can be awarded, e.g., cash, prizes when randomly selected winning game pieces match a plurality of playing game pieces on a participant's matrix to produce at least one column, row or diagonal of a plurality of game pieces in adjoining cells in that matrix. Thus, game participants still can win some prize for matching fewer than all of the winning game pieces so long as the plurality of matching game pieces occur “in-a-row.”

### BRIEF DESCRIPTION OF THE DRAWINGS

For a fuller understanding of the nature and desired objects of the present invention, reference is made to the following detailed description taken in conjunction with the accompanying drawing figures wherein like reference character denote corresponding parts throughout the several views and wherein:

FIG. 1 is an illustrative embodiment of a game ticket;

FIG. 2a is an illustrative embodiment of a game piece selection card;

FIG. 2b is a detail of one game section of a game piece selection card;

FIG. 3a is an illustrative embodiment of a 3×3 matrix;

FIG. 3b is an illustrative embodiment of a 4×4 matrix;

FIG. 3c is an illustrative embodiment of a 3×4 matrix;

FIG. 3d is an illustrative embodiment of a circular grid matrix; and

FIG. 3e is an illustrative embodiment of an interlocking grid matrix.

### DETAILED DESCRIPTION OF THE INVENTION AND ITS PREFERRED EMBODIMENTS

The present invention relates to an online game of chance and a method of and system for playing the game that potentially can produce more winning participants per drawing event; that can allow game participants to win prizes for matching fewer than all of the plurality of winning game pieces; and, moreover, that can provide each game participant with one or more possible winning combinations on a single playing ticket 10. Indeed, prizes, e.g., cash jackpots, can be calculated according to the total number of, e.g., horizontal, vertical and/or diagonal, winning lines L completed in a, e.g., three-by-three (3×3), matrix 20 much like in a game of tic-tac-toe. For example, a winning line L comprises any plurality of, e.g., three, adjoining cells 25, which can occur horizontally, vertically and/or diagonally, of playing game pieces X that match any of the game pieces comprising the combination of winning game pieces.

The game can be played by a plurality of game participants. Each game participant can obtain a game ticket 10 on which can be printed a matrix 20. The matrix 20 comprises a plurality of cells 25 that can be formed by the intersection of a plurality of columns G, H, I, which can be delineated by, e.g., lines, oriented approximately orthogonally to a plurality of rows A, B, C, which similarly can be delineated by, e.g., lines. Each cell 25 can contain a playing game piece X, which game participants can select personally, i.e., self-select, from the population of game pieces. A matrix 20 that is populated by playing game pieces X becomes a game participant's array.

In a preferred embodiment, playing game pieces X are selected without replacement, i.e., that each game piece in the population of game pieces is capable of being selected only once per drawing event, from a population of game pieces, e.g., integers from 1 to 27. However, in additional embodiments of the present invention, the population of game pieces can be much larger and/or playing game pieces X can be selected to populate a cell 25 more than once, i.e., with replacement.

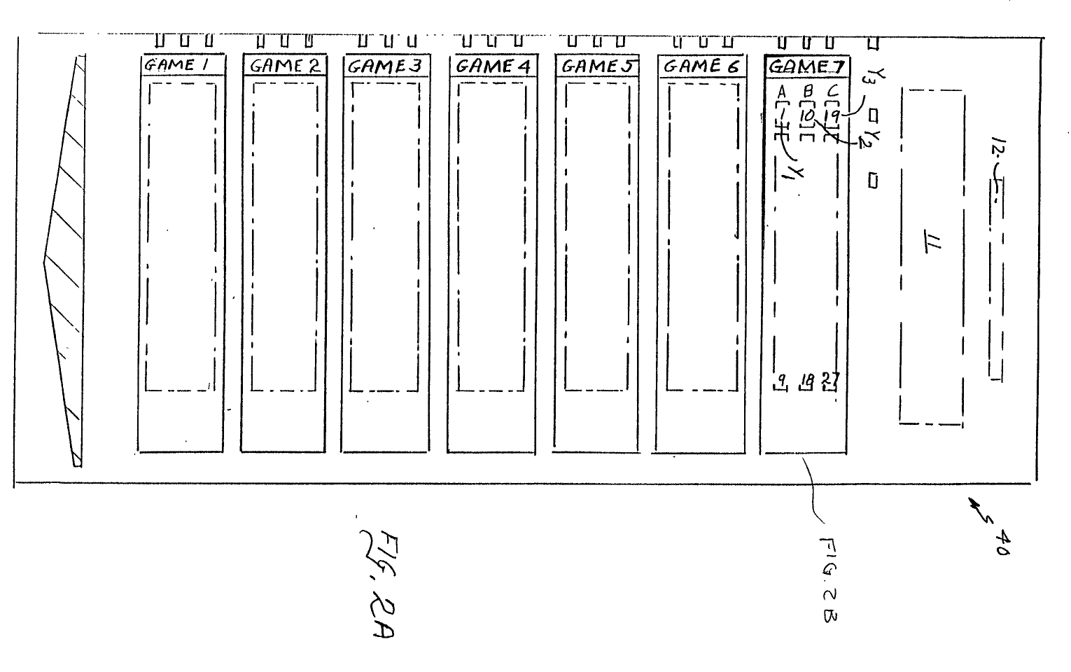

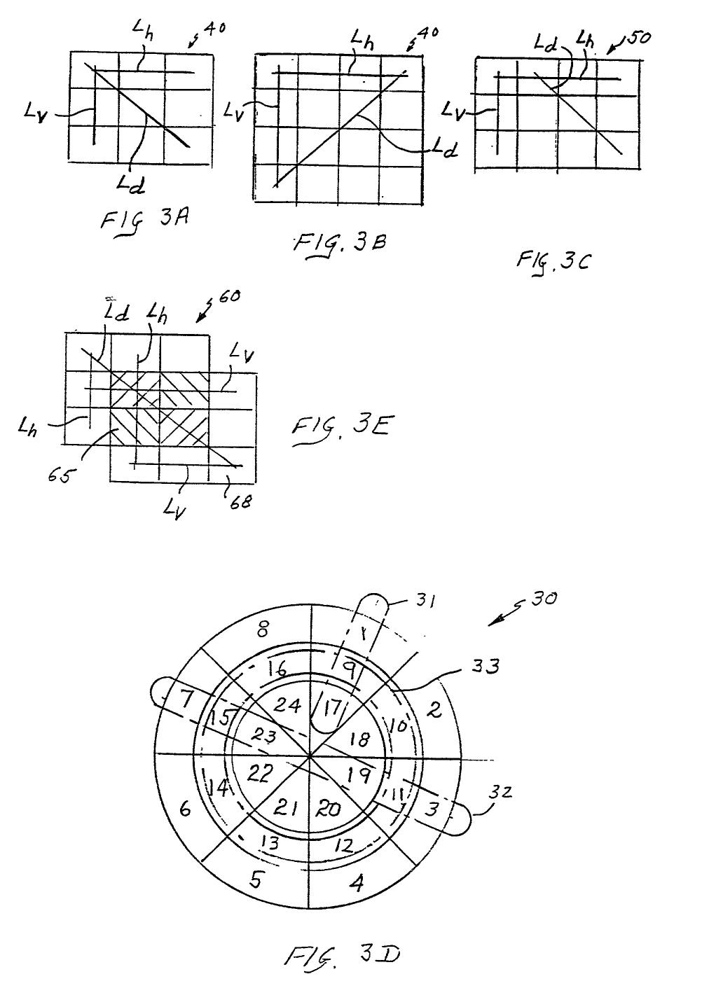

For example, a plurality of game participant can select a plurality of playing game pieces X from the population of game pieces to populate the plurality of open cells 25 in the matrix 20. Indeed, for a 3×3 matrix (FIG. 3A), a plurality of game participants can select nine playing game pieces X to populate the matrix 20. For a 3×4 matrix (FIG. 3C), game participants can select twelve playing game pieces X to populate the matrix 20, etc. Selection can be made, e.g, using a selection card 40 (FIG. 2A). Although, there are other selection methods that are known to those of ordinary skill in the art that also can be used without violating the scope and spirit of the disclosed invention.

In a preferred embodiment, however, selection can be completed using a selection card 40, which can be a punch-type or mark/sense-type (computer) card. A single selection card 40 can be used for playing one or more games for a single drawing event and/or for playing the same game or games for a plurality of drawing events occurring on a plurality of dates.

In one embodiment (not shown) of a selection card 40, the card 40 can comprise a plurality of matrix cell addresses beneath each of which can be the total population of game pieces. With this embodiment, game participants can select a discrete playing game pieces X for each matrix cell address, which provides participants with the greatest flexibility and freedom of choice. In another embodiment, game participants can select playing game pieces X in gross from the total population of game pieces. In this embodiment, the selection card 40 comprises at least one population of game pieces. Game participants select their playing game pieces X, which then can be arranged in the plurality of matrix cells 25 automatically, e.g., in ascending, descending or random order, by a server having software therefor.

In a preferred embodiment, however, a selection card 40 comprises a plurality of groupings of discrete numbers Y₁, Y₂, Y₃, etc. This plurality of groupings of discrete numbers Y₁, Y₂, Y₃, etc. can be dedicated to a specific cell 25, to an entire matrix row A, B, C, and/or to an entire matrix column G, H, I. For example, FIGS. 2A and 2B show an illustrative example of a mark/sense-type, i.e., computer, selection card 40, which, for illustrative purposes only, can support a 3×3 matrix 20 (FIG. 3A). For this exemplary selection card 40, game participants can select three playing game pieces X from a partial population of numbers Y₁, e.g., integers from 1 to 9, to populate matrix row A; three playing game pieces X from a partial population of numbers Y₂, e.g., integers from 10 to 18, to populate matrix row B; and three playing game pieces from a partial population of numbers Y₃, e.g., integers from 19 to 27, to populate matrix row C. In a variation of this embodiment, in which columns instead of rows are populated, game participants can select three playing game pieces X from a partial population of numbers Y₁, e.g., integers from 1 to 9, to populate matrix column G; three playing game pieces X from a partial population of numbers Y₂, e.g., integers from 10 to 18, to populate matrix column H; and three playing game pieces from a partial population of numbers Y₃, e.g., integers from 19 to 27, to populate matrix column I. In either of these embodiments, the playing game pieces X selected from the partial populations Y₁, Y₂, Y₃, can be arranged automatically, e.g., in ascending, descending or random order, respectively, in matrix rows A, B, and C or in matrix columns G, H, and I, by at least one server having software therefor.

In yet another embodiment, game participants can select a discrete playing game piece X₄ from, e.g., a partial population Y₁, e.g., integers from 1 to 9, which can be assigned to the matrix cell 25 formed by row A and column G. Similarly, participants can select another discrete playing game piece X₅ from a partial population Y₂, e.g., integers from 10 to 18, which can be assigned to the matrix cell 25 formed by row A and column H, and so forth. This particular embodiment, can provide game participants with greater flexibility and freedom of selection than is the case when playing game pieces X populate an entire row or column.

In still another embodiment, at least one free space F can populate one or more random cells 25. In this alternate embodiment, game participants can select one less playing game piece X for each free space F in the matrix 20. For example, for a 3×3 matrix 20 with one free space F, a game participant can select eight playing game pieces X to populate his or her matrix 20, i.e., 9 minus 1.

In this embodiment, wherein one or more free spaces can be included, game participants can select playing game pieces X from the total population of game pieces in any manner described in the previous embodiments. Moreover, game participants also can arrange their playing game pieces X in the plurality of matrix cells 25 that is not occupied by a free space F, if any, in any manner described in the previous embodiments.

As an alternative to self-selection using a selection card 40, another embodiment of the present invention comprises at least one server, having at least one database containing the population of game pieces, which can automatically populate a plurality of open matrix cells 25 with a plurality of playing game pieces X, selected at random from the population of game pieces, e.g., by “quick pick”, using software therefor. Indeed, an electronic, random number generator (not shown) can select a plurality of playing game pieces X from the population of game pieces and can arrange them randomly in the plurality of cells 25 in the participant's matrix 20 automatically. However, this embodiment can be restrictive as game participants can exercise no control over which playing game pieces X are selected and/or in determining which cell 25 each playing game piece X populates.

Once a game participant has indicted his or her selections on a selection card 40 and has indicated, further, the date of the drawing event in a space provided on the card 40 therefor, the selection card 40 can be introduced into a local reader (not shown), which can be connected via a network to at least one server (not shown). The reader can read the game participant's array on the selection card 40 and can digitize the participant's array and any other information thereon. Furthermore, the reader can provide the digitized array and other information, e.g., the date of the drawing event and a point of sale identifier, to at least one server, where it can be stored temporarily in a database provided therefor; and can provide the digitized array and other information, including, e.g., a point of sale terminal identifier and the date of the drawing event, to a local printer (not shown), which can produce a game ticket 10.

The at least one server of the present invention is a key elements thereof. Indeed, the server facilitates (i) calculating the odds for each number of winning lines L for each drawing event; (ii) determining the number of winning game tickets 10 per drawing event; and (iii) determining the corresponding number of winning lines L per winning game ticket 10 for each drawing event. By connecting the at least one server with remote readers and, in one embodiment, an electronic random number generator, information can be digitized, stored in at least one server database, and searched for winning lines L rapidly, which can offer game participants real time rewards.

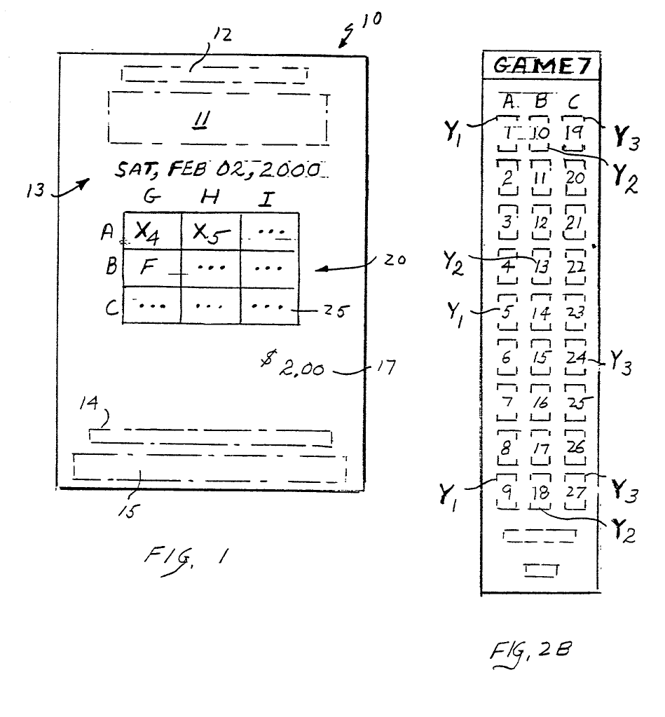

The printer (not shown) can be connected to the reader via a network and can produce a game ticket 10 as a record of the game participant's array (FIG. 1). An illustrative embodiment of a game tickets 10 comprises a matrix 20, each cell 25 of which can be filled with a playing game piece X selected from the population of game pieces or one or more free spaces F. Also provided on the game ticket 10 can be one or more of the following: the name of the game 11, the game owner/sponsor 12, the date of the drawing event 13, the cost of the game ticket 17, and the ticket serial number 14. Other information, including graphics, drawings, etc. also can be printed on the game ticket 10 without violating the scope and spirit of this disclosure.

A game participant's array and other information, including, e.g., a point of sale terminal identifier and the date of the drawing event, also can be provided, e.g., in a machine-readable bar code format 15 on, e.g., the bottom of, the game ticket 10. Alternately, the array and other information may be stored on a machine-readable magnetic stripe (not shown). Providing the array and other information in a bar code or magnetic stripe format facilitates authentication of a game ticket 10, which is discussed in greater detail below.

A method of playing the game of the present invention further comprises the steps of drawing or generating a plurality of winning game pieces from the population of game pieces and determining the number of winning game tickets 10 and the number of winning lines L per winning game ticket 10 for each drawing event can be chosen only once per drawing event. Winning game pieces can be selected, manually, e.g., using a manual drawing device, e.g., a drum; or generated electronically, e.g., using an electronic random number generator.

In a preferred embodiment, winning game pieces can be drawn randomly without replacement; which is to say that game pieces in the population of game pieces can be chosen only once per drawing event. The number of winning game pieces that can be drawn should be greater than or equal to the number of open cells 25 on a game ticket 10 but less than the total population of game pieces. For example, with a 3×3 matrix 20, no free spaces F, and a population comprising 27 numbers, at least nine but no more than 26 winning game pieces can be drawn. Using the same example but allowing for one free space F, at least 8 but no more than 26 winning game pieces can be drawn. As a practical matter, however, it is preferable that the number of winning game pieces drawn should be equivalent to the number of open cells 25 on a game ticket 10. Or, in the alternate, the number of winning game pieces drawn should be equivalent to one more than the number of open cells 25 on a game ticket 10. Furthermore, drawing fewer winning game pieces can reduce the probability of getting a winning line L. Therefore, the actual number of winning game pieces that can be drawn during a drawing event should be determined statistically to generate odds that induce participation. Similarly, the probability of getting a winning line L can be reduced when the population of game pieces is larger. Thus, while any size population can be possible, population size also should be determined statistically to generate odds that induce participation while providing adequate return to the lottery sponsor or owner.

Winning game pieces can be selected from the total population of game pieces. However, in a preferred embodiment corresponding to the game ticket 10 shown in FIGS. 2A and 2B, three winning numbers can be drawn from the partial population of numbers Y₁ from 1 to 9; three winning numbers can drawn from the partial population of numbers Y₂ from 10 to 18; and three winning numbers can be drawn from the partial population of numbers Y₃ from 19 to 27.

Determining the number of winning game tickets 10 and the number of winning lines L per winning game ticket can be performed by one or more servers, having software therefore. It is preferred that the one or more servers can be the same server that contains the database of the game participant's arrays to facilitate the process. Moreover, the one or more servers can be connected to the electronic random number generator via the network so that as each number is randomly generated, the one or more servers can search the database containing participants' array data to identify rapidly all winning game tickets 10 and the number of winning lines L per winning game ticket 10. If, however, winning game pieces are selected manually, then determining the number of winning game tickets 10 and winning lines L per game ticket 10 must follow an additional step of manually inputting the winning game pieces into at least one server, having software therefore, that is connected to the network.

Winning the game is based on the principle of tic-tac-toe, i.e., “three-in-a-row”. Hence, a game ticket 10 can be a winning game ticket 10 if a game participant's array includes at least one, e.g., horizontal, vertical and/or diagonal, line L that comprises a plurality of, but at least three, adjoining cells 25 that contain playing game pieces X that match any of the winning game pieces. Playing game pieces X can be compared to the combination of winning game pieces to determine whether a particular game ticket 10 has one or more winning lines L. Prizes can be awarded for each winning line L. The greater the number of winning lines L, the larger the prize that can be awarded.

Indeed, a game participant becomes a winning game participant when he or she has one or more winning lines L, i.e., “three-in-a-row” for a 3×3 matrix 20, on his or her game ticket 10. Winning lines L may occur, e.g., horizontally Lh, vertically Lv, and/or diagonally Ld. The table below shows the representative odds of getting 1, 2, 3, 4, 5, 6, or 8 winning lines L on a single 3×3 matrix game ticket 10 when nine winning numbers are selected from a population of 27 numbers. Seven winning lines L are not possible.

| Number of | Odds/Card |
|---|---|
| Winning Lines | (#: 1) |
| 1 Line | 6 |
| 2 Lines | 47 |
| 3 Lines | 263 |
| 4 Lines | 1,674 |
| 5 Lines | 7,903 |
| 6 Lines | 24,696 |
| 8 Lines | 592,704 |

FIGS. 3A through 3E illustrate a number of exemplary embodiments of the present invention. Indeed, FIGS. 3A and 3B illustrate exemplary embodiments of square matrices 40, respectively, for a 3×3 and a 4×4 grid 20. For these matrix-types 40, winning lines L comprise horizontal Lh, vertical Lv, and/or diagonal Ld lines of three and four, respectively. FIG. 3C illustrates an exemplary embodiment of a rectangular matrix 50 for a 3×4 grid. For this matrix-type, winning lines L comprise lines of three in a vertical or diagonal direction and/or lines of four in a horizontal direction. FIG. 3D illustrates an exemplary embodiment of a circular, or “dartboard”, matrix 30, in which potential winning lines L can correspond to a segment 31 of the circle, two segments of the circle that are diametrically opposed to one another 32, and/or circumferentially adjoining segments 33. FIG. 3E illustrates an embodiment of an interlocking grid matrix 60, wherein game participants can select a plurality of, e.g., four, playing game pieces X, which can be inserted in the shaded boxes 65 in the center of the matrix grid 60. An electronic number generator can insert game pieces that have been randomly selected from the population of game pieces in the remaining, e.g., ten, perimeter boxes 68. For this “shared grid” matrix 60, winning lines L of three and/or four are required to win. Game participants also can win if any of the winning game pieces match all of the playing game pieces X appearing in the central, shaded boxes 65.

Game participants can watch the drawing event as it takes place, e.g., on commercial or closed circuit television. When a game participant believes that he or she has at least one winning line L, the game participant can take the game ticket 10 to the original point of sale or any point of sale for authentication. Authentication comprises the steps of reading the, e.g., bar code or magnetic stripe information 15 on the game ticket 10 using a reader that is connected to at least one server via the network, and comparing that information with participant array information that is stored in at least one server database. If the date of drawing event, point of sale identifier, and participant's array information contained on the game ticket 10 coincides with similar information stored in the at least one server database, then the game ticket 10 can be authenticated, which entitles the game participant to receive his or her prize.

Winning numbers that can form winning lines L do not necessarily have to be drawn, however. Indeed, playing game pieces X can be based on the results or occurrence of certain, e.g., sporting, events. For example, winning lines L can be based on results of a plurality of horse races, wherein game participants enter in appropriate matrix cells 25 the jockey's jersey number of the horses that they expect to win, place, and show in a plurality of designated races. In another example, winning lines L cay be based on a plurality of football, basketball and/or hockey scores, wherein participants can enter, e.g, the points or goals scored by each team per quarter or period in appropriate matrix cells 25. In yet another embodiment, winning lines L can be based on baseball box scores, wherein game participants can enter, e.g., the number of runs, hits and errors of the opposing teams; or, alternatively, the number of runs, hits, and uniform number of players who hit a home run during the game. In the previous examples, selection can be with replacement due to the likelihood of similar scores. In a further example, winning lines L can be based on the Dow Jones or NASDAQ daily closing averages. Indeed, a virtually endless list of game piece populations can be possible, all of which are within the scope and spirit of the disclosed invention.

Furthermore, the game of the present invention can be played using non-numeric game pieces X in lieu of numbers without violating the scope and spirit of the disclosed invention. Indeed, the population of game pieces can be different fruit types, e.g., such as cherries, lemons, and/or oranges, or letters of the alphabet, or other symbols, e.g., such as bells, road signs, etc. These examples of population game pieces are not meant to be exhaustive, rather, merely illustrative to demonstrate the versatility of potential game pieces.

While a number of embodiments of the invention have been described, it should be obvious to those skilled in the art that other embodiments to and/or modifications, combinations, and substitutions of the present invention are possible, all of which are within the scope and spirit of the disclosed invention.

What is claimed is:

1. A game of chance played on a network for a plurality of game participants, each of the plurality of game participants having at least one game ticket, the game comprising:
a population of game pieces;
a first selection device for populating a plurality of cells in at least one matrix on a plurality of game tickets, wherein the first selection device populates a plurality of open cells of the plurality of cells with a plurality of playing game piece selected from the population of game pieces to produce a plurality of arrays; and
a second selection device for randomly selecting a plurality of winning game pieces from the population of game pieces; wherein at least one of the plurality of game participants can win a prize when any combination of winning game pieces matches a plurality of playing game pieces located in adjoining cells of the plurality of cells in the at least one matrix on the plurality of game tickets to produce one or more winning lines.

2. The game of claim 1 wherein the first selection device for populating a plurality of open cells comprises a selection card.

3. The game of claim 2 wherein the selection card is a punch-type card.

4. The game of claim 2 wherein the selection card is a mark/sense-type card.

5. The game of claim 1 wherein the first selection device comprises at least one server, having software to populate the plurality of open cells automatically.

6. The game of claim 1 wherein the plurality of cells includes one or more free spaces.

7. The game of claim 1 wherein the second selection device for randomly selecting a plurality of winning game pieces comprises an electronic random number generator that is connected to the network.

8. The game of claim 1 wherein the second selection device for randomly selecting a plurality of winning game pieces comprises a manual drawing machine.

9. The game of claim 1 wherein random selection of a plurality of winning game pieces is performed without replacement.

10. The game of claim 1 wherein the one or more winning lines comprises a plurality of cells that are adjoining in a horizontal, vertical or diagonal direction.

11. The game of claim 10 wherein the plurality of cells comprises at least three adjoining cells.

12. The game of claim 1 further comprising a video display for displaying the randomly selected winning game pieces.

13. The game of claim 1 wherein the population of game pieces comprises whole numbers from 1 to 27.

14. The game of claim 1 wherein the at least one matrix is selected from the group comprising a rectangular matrix, a square matrix, a circular matrix, and a shared grid matrix.

15. The game of claim 1 wherein the network further comprises:
at least one server having:
at least one database accessible by the at least one server for storing the plurality of game participant's arrays;
at least one database accessible by the at least one server for storing the population of game pieces from which the second selection device samples to produce the winning game pieces; and
software operable on the at least one server for determining the number of winning game tickets and the number of winning lines on each winning game ticket; for calculating at least one prize payout; and
for authenticating at lease one winning game ticket;
a printer, which is connected to the network, to produce a plurality of game tickets; and
a reader, which is connected to the network, wherein the reader provides each of the plurality of game participant's arrays to the at least one server for storage in the database therefor and to the printer for use in producing the plurality of game tickets.

16. A method of playing a game of chance, having a plurality of game participants each of the plurality of game participants having at least one game ticket, on a network, the method comprising the steps of:
populating a plurality of open cells of a plurality of cells with a plurality of playing game pieces selected from a population of game pieces, wherein the plurality of cells produces at least one matrix on a plurality of game tickets;
randomly selecting a plurality of winning game pieces from the population of game pieces;
determining the number of winning lines on the plurality of game tickets of the plurality of game participants; and
awarding at least one prize to at least one game participant, wherein the at least one prize is awarded based on the number of winning lines at least one winning game ticket.

17. The method of claim 16 wherein the plurality of open cells are populated automatically by at least one server, which is connected to the network, using software therefor.

18. The method of claim 16 wherein the plurality of open cells are populated manually using a selection card.

19. The method of claim 18 wherein the selection card is a punch-type card.

20. The method of claim 18 wherein the selection card is a mark/sense-type card.

21. The method of claim 16 wherein the plurality of cells is populated by one or more free spaces.

22. The method of claim 16 wherein randomly selecting a plurality of winning game pieces is performed by a selection device.

23. The method of claim 22 wherein the selection device comprises an electronic random number generator that is connected to the network.

24. The method of claim 22 wherein the selection device comprises a manual drawing machine.

25. The method of claim 16 wherein determining the number of winning lines is performed automatically by at least one server, which is connected to the network, having software therefor.

26. The method of claim 16 wherein the at least one winning line comprises a plurality of cells that are adjoining in a horizontal, vertical or diagonal direction.

27. The method of claim 26 wherein the plurality of cells comprises at least three adjoining cells.

28. The method of claim 16 further comprising the additional step of displaying the randomly selected winning game pieces on a video display.

29. The method of claim 16 further comprising the additional step of storing the plurality of playing game pieces for each of the plurality of game participants in at least one server, which is connected to the network, having at least one database therefor.

30. The method of claim 16 further comprising the additional step of authenticating a plurality of winning game tickets.

31. The method of claim 16 further comprising the additional step of producing the plurality of game tickets.

32. The method of claim 31 wherein the plurality of game tickets is produced by at least one printer, which is connected to the network.

33. A system for playing a game of chance, having a plurality of game participants, on a network, the system comprising:
at least one server, which is connected to the network, wherein the at least one server comprises:
at least one database for storing a plurality of arrays of playing game pieces populating a plurality of opens cells in a plurality of cells in at least one matrix on a plurality of game tickets of the plurality of game participants, and
at least one database for storing a population of game pieces;
a first selection device for selecting a plurality of playing game pieces from the population of game pieces to produce the plurality of arrays;
a second selection device, which is connected to the network, for randomly selecting a plurality of winning game pieces from a population of game pieces; and
at least one local printer, which is connected to the network, for producing at least one game ticket.

34. The system of claim 33 wherein the at least one server has software for:
automatically populating the plurality of open cells in the plurality of cells in the at least one matrix on the plurality of game tickets;
determining the number of winning game tickets and the number of winning lines on each of at least one winning game tickets;
calculating at least one prize payout; and
authenticating at least one winning game ticket.

35. The system of claim 33 wherein the first selection device comprises a selection card.

36. The system of claim 35 wherein the selection card is a punch-type card.

37. The system of claim 35 wherein the selection card is a mark/sense-type card.

38. The system of claim 33 wherein the plurality of cells includes one or more free spaces.

39. The system of claim 33 wherein the second selection device for randomly selecting a plurality of winning game pieces comprises an electronic random number generator that is connected to the network.

40. The system of claim 33 wherein the second selection device for randomly selecting a plurality of winning game pieces comprises a manual drawing machine.

41. The system of claim 33 wherein random selection of a plurality of winning game pieces is performed without replacement.

42. The system of claim 34 wherein the winning lines comprise a plurality of cells that are adjoining in a horizontal, vertical or diagonal direction.

43. The system of claim 42 wherein the plurality of cells comprises at least three adjoining cells.

44. The system of claim 33 further comprising a video display for displaying the randomly selected winning game pieces.

45. The system of claim 33 wherein the at least one matrix is selected from the group comprising a rectangular matrix, a square matrix, a circular matrix, and a shared grid matrix.

46. The system of claim 33 further comprising:
a reader, which is connected to the network, wherein the reader provides each of the plurality of game participant's arrays to the at least one server for storage in the database therefor and to the printer for use in producing the plurality of game tickets.
